(19) United States
(12) Patent Application Publication
(10) Pub. No.: US 2013/0068058 A1
(43) Pub. Date: Mar. 21, 2013

(54) BALL SCREW HOLDING SYSTEM FOR INSERT

(71) Applicants: Eric ALLEGRI, MONTMELIAN (FR); Christophe DURAND, BASSENS (FR)

(72) Inventors: Eric ALLEGRI, MONTMELIAN (FR); Christophe DURAND, BASSENS (FR)

(73) Assignee: AKTIEBOLAGET SKF, Goteborg (SE)

(21) Appl. No.: 13/623,493

(22) Filed: Sep. 20, 2012

(30) Foreign Application Priority Data
Sep. 21, 2011 (FR) 1158399

(51) Int. Cl. F16H 25/22

(52) U.S. Cl. 74/424.87

(57) ABSTRACT

Ball screw system comprising a screw having an external threading, a nut having an internal threading and a series of balls being engaged in the threadings to link the screw and the nut, the nut comprising ball recirculation means comprising at least one ball deflection element inserted into a through hole of the wall of the nut, from outside to inside as far as abutment means, in which the nut is equipped with a retaining means which bears on a peripheral wall of this nut, over at least a part of its length, and which bears on an external face of the deflection element, the permanent retaining means being self-held and ensuring that the deflection element is held permanently in the through hole.

### FIELD OF THE INVENTION

The present invention relates to the field of ball screw systems.

### BACKGROUND OF THE INVENTION

Ball screw systems comprise a screw having an external threading and a nut having an internal threading, which are linked by a series of balls, the nut being provided with a ball recirculation means which comprises ball deflection elements. According to one type of mounting, the deflection elements are inserted from outside, in abutment, into holes of the nut and are fixed to the latter by gluing.

The aim of the present invention is to propose another type of mounting, simpler to implement and more secure.

### SUMMARY OF THE INVENTION

A ball screw system is proposed which comprises a screw having an external threading, a nut having an internal threading and a series of balls being engaged in the threadings to link the screw and the nut, the nut comprising ball recirculation means comprising at least one ball deflection element inserted into a through hole of the wall of the nut, from outside to inside as far as abutment means.

The nut is equipped with a retaining means which bears on a peripheral wall of this nut, over at least a part of its length, and which bears on an external face of the deflection element, the permanent retaining means being self-held and ensuring that the deflection element is held permanently in the through hole.

The peripheral wall of the nut may have at least one groove in which the retaining means can be engaged.

The external face of the deflection element may have at least one groove in which the retaining means is engaged.

The groove of the nut and the groove of the deflection element can form a peripheral channel.

According to a variant embodiment, the permanent retaining means may comprise a closed ring surrounding the nut, it being possible for this ring to be made of an elastic material.

The closed ring may be made of a synthetic material or of rubber.

According to another variant embodiment, the permanent retaining means may comprise an open ring made of an elastic material, this open ring being able to be extended by a folded-back end part, introduced into a recess of the nut at a distance from the through passage.

The hole receiving the folded-back end part of the open ring may be blind.

The open ring may be made of an elastic metal material.

The retaining means may be completely inserted into a peripheral channel.

The bearing of the retaining element on the external face of the retaining element may be, peripherally, slightly protruding in relation to the bearing of the retaining element on the peripheral wall of the nut.

The ball recirculation means may comprise two deflection elements held by two retaining means, the deflection means forming two ball deflection passages, the nut having a longitudinal hole linking these deflection passages, the deflection elements being provided with internal fingers for extracting and reintroducing the balls at the ends of the ball circulation path in the nut.

### BRIEF DESCRIPTION OF THE DRAWINGS

A ball screw system equipped with permanent retaining means will now be described as a nonlimiting example and illustrated by the drawing in which:

FIG. 1 represents a longitudinal cross section of a ball screw system;

FIG. 2 represents a perspective external view of the ball screw system of FIG. 1;

FIG. 3 represents a radial cross section of the ball screw system of FIG. 1, equipped with retaining means according to a variant embodiment; and

FIG. 4 represents a radial cross section of the ball screw system of FIG. 1, equipped with retaining means according to another variant embodiment.

### BRIEF DESCRIPTION OF THE DRAWINGS

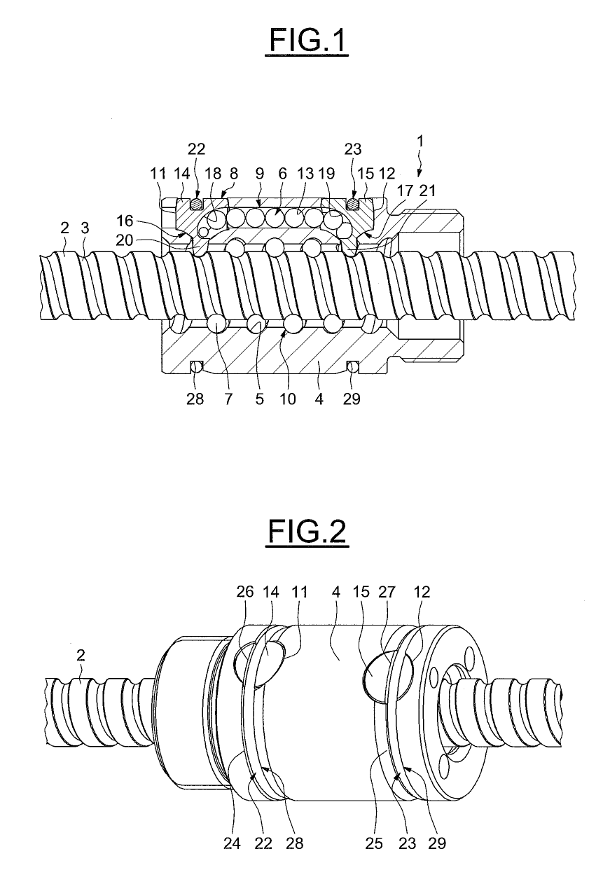

As illustrated in FIGS. 1 and 2, a ball screw system 1 comprises a longitudinal screw 2 having an external threading 3, a cylindrical nut 4 having an internal threading 5, the internal diameter of which is slightly greater than the external diameter of the screw 2, a series 6 of spherical balls 7 linking the screw 2 and the nut 4 and recirculation means 8 borne by the nut 4 and defining a recirculation channel 9.

The series of balls 7 is such that balls, engaged radially and partially in the threading of the screw 2 and partially in the threading 5 of the nut 4, circulate along a circulation path 10 in the nut 4, which can extend over several turns, while other balls circulate in the recirculation channel 9.

A rotation of the screw 2 in relation to the nut 4 is converted into a translational movement of one in relation to the other by the fact that balls 7 roll in the threadings 3 and 5 along the circulation path 10 and roll freely along the recirculation channel 9, respectively between the common ends of the circulation path 10 and of the recirculation channel 9.

According to the example represented, the recirculation means 8 defining the recirculation channel 9 are arranged as follows.

The wall of the nut 4 is provided with two secondary holes 11 and 12 passing through its thickness and spaced apart longitudinally and is provided with a longitudinal hole 13 linking the holes 11 and 12.

The through holes 11 and 12 have deflection elements 14 and 15 inserted into them which are, from outside to inside, held by abutment means 16 and 17 formed in the secondary holes 11 and 12 and on these deflection elements 14 and 15, for example by conjunction of toroidal or tapered forms. According to the example represented, the external faces of the deflection elements 14 and 15 are in the extension of the cylindrical external face of the nut 4.

The deflection elements 14 and 15 delimit, with the surfaces of the secondary holes 11 and 12, arc-shaped deflection passages 18 and 19 which open out inside the nut 4 in the area of the ends of the circulation path 10 and which, respectively, tangentially meet the ends of the longitudinal hole 13 of the nut 4, in such a way that the deflection passages 18 and 19 and the longitudinal hole 13 form the recirculation channel 9.

The deflection elements 14 and 15 are provided with internal fingers 20 and 21 for extracting and reintroducing the balls 7 at the ends of the circulation path 10. These fingers 20 and 21 are engaged in the threading 3 of the screw 2, so that, upon the rotation of the screw 2 in relation to the nut 4, the balls 7, one after the other, are extracted by one of the fingers 20 or 21 at one of the ends of the circulation path 10, circulate freely in the recirculation channel 9, and are reintroduced by the other finger 20 or 21 at the other end of the circulation path 10.

The nut 4 is equipped with permanent retaining means 22 and 23 ensuring that the deflection elements 14 and 15 are permanently held, from outside, in the secondary holes 11 and 12, in the direction of the abutment means 16 and 17.

The external face of the nut 4 has external peripheral grooves 24 and 25, the ends of which open out into the secondary holes 11 and 12 and the external faces of the deflection elements 14 and 15 have external grooves 26 and 27 which are in the extension of the grooves 24 and 25, so that, on the one hand, the groove 24 of the nut 4 and the groove 26 of the deflection element 14 form a peripheral channel 28 and, on the other hand, the groove 25 of the nut 4 and the groove 27 of the deflection element 15 form a peripheral channel 29.

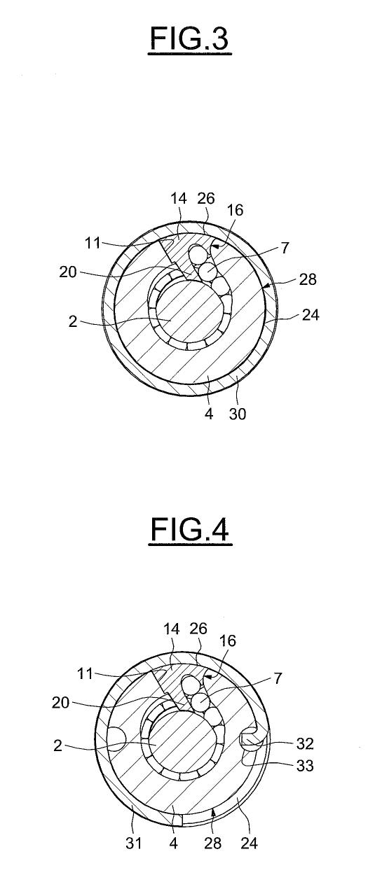

According to an example illustrated in FIG. 3, the permanent retaining means 22 and 23 are formed by closed toric rings 30 surrounding the nut 4, which are arranged and extend in the peripheral channels 28 and 29, bearing against the bottom thereof. These closed rings 30 are made of an elastic material and are taut, so that they are self-held in the peripheral channels 28 and 29.

The closed rings 30, permanently bearing against the bottom of the grooves 26 and 27, exert permanent forces on the deflection elements 14 and 15, from outside to inside, towards the abutment means 16 and 17, so that the deflection elements 14 and 15 are held permanently and avoiding any vibration. According to a variant embodiment, in order to be sure that there is a permanent contact of the elastic rings 30 on the deflection elements 14 and 15, the bottoms of the grooves 26 and 27, at least over a part of their length, could be designed to protrude outward relative to the circumference of the bottoms of the grooves 24 and 25 of the nut 4.

For their mounting, the closed rings 30 are enlarged against their elasticity, then they are made to slide longitudinally around the nut 4, and they are allowed to be introduced into the peripheral channels 28 and 29 under the effect of their elasticity.

The sections of the peripheral channels 28 and 29 and of the closed rings 30 can be such that the closed rings 30 occupy the peripheral channels 28 and 29 and are completely inserted into the latter so that the closed rings 30 do not extend outward relative to the external faces of the nut 4 and of the deflection elements 14 and 15.

The closed rings 30 can be made of a synthetic material, or of rubber, or of metal. In the latter case, the mounting can be done by heating the metal closed rings 30.

According to another example illustrated in FIG. 3, the permanent retaining means 22 and 23 are formed by open rings 31 which surround the nut 4 and which are arranged and extend in the peripheral channels 28 and 29 over approximately three quarters of the perimeter of the nut 4, bearing against the bottom of these channels 28 and 29. These open rings 31 are made of an elastic material, for example of a sprung metal material, and are self-held in the peripheral channels 28 and 29 under the effect of their elasticity.

The open rings 31 are, at one of their ends, extended by end parts 32 folded radially inward, introduced into blind recesses 33 of the nut 4 formed in the bottom of the peripheral channels 28 and 29. The blind holes 33 are at a distance from the secondary holes 11 and 12, for example by approximately a quarter turn. The other ends of the open rings 31 are, for example, diametrically opposite the deflection elements 14 and 15, so that the deflection elements 14 and 15 are completely covered and passed through by the open rings 31.

The open rings 31, permanently bearing against the bottom of the grooves 26 and 27, exert permanent forces on the deflection elements 14 and 15, from outside to inside, towards the abutment means 16 and 17, so that the deflection elements 14 and 15 are held permanently and avoiding any vibration. According to a variant embodiment, in order to be sure that there is a permanent contact between the open ring 31 and the deflection elements 14 and 15, the bottom of the grooves 26 and 27 of the deflection elements 14 and 15 could be designed, over at least a part of their length, to protrude slightly relative to the circumference of the peripheral grooves 24 and 25 of the nut 4.

The mounting of each open ring 31 can be of “clip” type. For this, the folded part 32 is introduced into the recess 33 and pressure is applied to the ring radially. The latter is deformed elastically so that ultimately it is housed in the corresponding channel 28, 29 and almost reverts to its initial form.

As in the previous example, the sections of the peripheral channels 28 and 29 and of the open rings 31 can be such that the open rings 31 occupy the peripheral channels 28 and 29 and are completely inserted therein so that the closed rings 30 do not extend outward relative to the external faces of the nut 4 and of the deflection elements 14 and 15.

According to the examples which have just been described, the nut and the deflection elements have grooves which determine peripheral channels receiving the retaining rings. However, according to a variant embodiment, it could be only the nut that has grooves receiving the retaining rings, the retaining rings then bearing on the external surfaces of the retaining elements. According to another variant embodiment, it could be only the external surfaces of the deflection elements, protruding relative to the peripheral surface of the nut, that have grooves receiving the retaining rings, the retaining rings then bearing directly on the peripheral surface of the nut.

The examples described give the result that the proposed retaining means make it possible to avoid in any circumstances the ejection of the deflection elements.

The present invention is not limited to the examples described above. Many other variant embodiments are possible, without departing from the scope defined by the appended claims.

1. A ball screw system comprising:
a screw having an external threading,
a nut having an internal threading, and
a series of balls engaged in the threadings to link the screw and the nut, the nut including ball recirculation means providing at least one ball deflection element inserted into a through hole of the wall of the nut, from outside to inside as far as abutment means, and wherein
the nut is equipped with a retaining means which bears on a peripheral wall of the nut, over at least a part of its length, and which bears on an external face of the deflection element, and wherein
the permanent retaining means is self-held and ensures that the deflection element is held permanently in the through hole.

2. The system according to claim 1, wherein the peripheral wall of the nut has at least one groove in which the retaining means is engaged.

3. The system according to claim 1, wherein the external face of the deflection element has at least one groove in which the retaining means is engaged.

4. The system according to claim 2, wherein groove of the nut and the groove of the deflection element form a peripheral channel.

5. The system according to claim 1, wherein the permanent retaining means further comprises a closed ring surrounding the nut, this ring being made of an elastic material.

6. The system according to claim 5, wherein the closed ring is made of a synthetic material or of rubber.

7. The system according to claim 1, wherein the permanent retaining means further comprises an open ring made of an elastic material, and wherein
the open ring is extended by a folded-back end part, introduced into a recess of the nut at a distance from the through passage.

8. The system according to claim 7, wherein the hole receiving the folded-back end part of the open ring is blind.

9. The system according to claim 7, wherein the open ring is made of an elastic metal material.

10. The system according to claim 1, wherein the retaining means is completely inserted into a peripheral channel.

11. The system according to claim 1, wherein the bearing of the retaining element on the external face of the retaining element is, peripherally, slightly protruding in relation to the bearing of the retaining element on the peripheral wall of the nut.

12. The system according to claim 1, wherein the ball recirculation means further comprises two deflection elements held by two retaining means, the deflection means forming two ball deflection passages, the nut having a longitudinal hole linking these deflection passages, the deflection elements being provided with internal fingers for extracting and reintroducing the balls at the ends of the ball circulation path in the nut.
